(19) United States
(12) Patent Application Publication
(10) Pub. No.: US 2014/0057704 A1
(43) Pub. Date: Feb. 27, 2014

(54) Method and System for Transfer of Credits Between Gaming Machines

(71) Applicants: Steven Arntzen, Billings, MT (US); Susan Stone, Las Vegas, NV (US)

(72) Inventors: Steven Arntzen, Billings, MT (US); Susan Stone, Las Vegas, NV (US)

(73) Assignee: CENTURY GAMING, INC., Billings, MT (US)

(21) Appl. No.: 13/975,262

(22) Filed: Aug. 23, 2013

Related U.S. Application Data
(60) Provisional application No. 61/693,364, filed on Aug. 27, 2012.

(51) Int. Cl. G07F 17/32

(52) U.S. Cl. CPC G07F 17/3244
USPC 463/25

(57) ABSTRACT

A method and system for use in an establishment with an attendant responsible for monitoring and handling activity on a group of electronic gaming machines in a gaming establishment. Once a player has gaming credits available for play on an electronic gaming machine, the player may elect to continue play, cash-out or transfer credits to a different electronic gaming machine in the establishment. In the event the player elects either a cash-out or a transfer, the player alerts the attendant and the attendant executes a sequence of operations on the system to make a hand pay to the player, provide a credit voucher or to transfer the available credits to a different electronic gaming machine.

### RELATED APPLICATION INFORMATION

This application claims priority benefit from U.S. Provisional Patent Application Ser. No. 61/693,364, filed on Aug. 27, 2012, the entirety of which is incorporated by reference in the present application.

### COPYRIGHT NOTICE

Portions of this disclosure contain material in which copyright is claimed by the applicant. The applicant has no objection to the copying of this material in the course of making copies of the application file or any patents that may issue on the application, but all other rights whatsoever in the copyrighted material are reserved.

### BACKGROUND

Electronic gaming machines (“EGMs”) offer a variety of games such as slot games, video poker games, keno games and other types of wagering games that are commonly deployed at a gaming establishment such as a casino, the bar area of a restaurant, a convenience store or other location where EGMs are in operation for use by players. Play on the EGMs typically requires the player to place a wager on the outcome of the game. The games are programmed with a random number generator (“RNG”) to randomly generate outcomes and compare those outcomes to a predefined set of possible winning combinations and pay table amounts. The player is awarded for a winning outcome and receives no award for a losing outcome.

Most EGMs in use today include bill acceptors or bill validators that have the functionality to accept paper currency and track the number of “credits” or “game plays” that remain available for play at all times while the player engages in a session of play at the EGM. In casinos or other gaming establishments with large number of EGMs, the player may elect to continue play or cash-out after the end of each game played. If the player elects to continue play, he simply presses the play button, or another input that permits additional play(s) to occur. If the player elects to cash-out, a printed ticket is often dispensed with a bar code representing the value of the ticket along with other information such as the name of the establishment, the date, the value of the ticket and other information that may be useful for the player or the gaming establishment. The ticket that is printed at the EGM may be inserted into another EGM or taken to a pay station where the ticket is exchanged for cash, either manually by an attendant or through the use of a ticket changing machine that dispenses currency and/or coins. Systems of this type are known in the prior art and are discussed, for example, in U.S. Pat. No. 6,048,269 to Burns, et al. These types of systems are referred to as “ticket-in, ticket-out” or “TITO” systems.

While TITO systems provide many advantages in a large gaming establishment with hundreds or thousands of EGMs, such systems are not cost-effective or practical for use in small gaming establishments such as bars, restaurants, convenience stores, supermarket and other establishments with smaller numbers of machines where an employee (e.g. cashier or gaming attendant) is often part of the cash-out process.

Cost effective systems for payment of players to small gaming establishments such as bars, restaurants, convenience stores, and supermarkets are currently available. These systems track credits at each EGM connected to the system and give players the option to continue play or cash-out after each game is completed. In the event that a player would like to transfer credits from one machine to another machine without having to cash-out, the player must take the cash-out currency received from a gaming attendant, move to a new machine and start play at a new machine by inserting the currency into the bill validator of the new EGM. There is no way to electronically transfer credits from one EGM to another.

The present invention defines a method and system that allows players in a small establishment with a limited number of EGMs such as a bar, to elect to continue play, cash-out or transfer available credit that involves an attendant (e.g. a bartender), but is simple to use and cost-effective for the operator of the establishment having a limited number of EGMs. It does so by allowing a player to indicate to an attendant that he wants to move to a new EGM in the same establishment. The attendant can then issue a cashable ticket voucher to the player from a gaming establishment control system (“GECS”) with all or a portion of the credit balance on the ticket as instructed by the player. Any amount of the balance not included on the ticket is paid to the player in cash. The EGM at which the player is stationed is then locked out from further play by the attendant at the GECS until the cash-out transaction is completed. Once the player is provided with the ticket from the attendant, the player can move to a new EGM and insert the ticket into the new EGM to load the value of the credits onto the new EGM. Once the player has moved, the attendant instructs the GECS to “zero-out” the credits on the current EGM and unlocks the current EGM for play by a new player.

In an alternative embodiment, instead of being issued a printed ticket by the attendant, the player notifies the attendant that he wishes to move to a new EGM and informs the attendant to which new EGM he would like his credits transferred. The player may also indicate that he wants all or a portion of the credits transferred. The requested amount of credit to be transferred is then communicated to the GECS by the attendant with any difference between the available credit and the transferred amount being paid by the attendant to the player. The attendant instructs the GECS to “zero-out” the credits on the current EGM, and transfer those credits to the new machine indicated by the player. The player then moves to the new machine where the credits are now available for play, and the gaming attendant releases the prior EGM from its locked state at the GECS.

### BRIEF DESCRIPTION OF THE DRAWINGS

For a better understanding of the present invention, and to show more clearly how it functions, reference will now be made, by way of example, to the accompanying drawings. The drawings show embodiments of the present invention in which:

FIG. 1A shows an electronic gaming machine in the form of a video slot machine with reels for playing a game;

FIG. 1B shows an electronic gaming machine in the form of a bar-top video poker machine with a touchscreen for playing one or more video poker games;

FIG. 2 shows a group of electronic gaming machines connected to a network with a gaming establishment control system;

FIG. 3 shows internal components of a single electronic gaming machine and the gaming establishment control system on the network;

FIG. 4A shows a flow chart of operation of a method by which a player is able to continue play, cash out or transfer credits;

FIG. 4B shows a flow chart of operation of an alternative method by which a player is able to continue play, cash out or transfer credits; and

FIG. 5 shows a screen display of a map of a bar area including electronic gaming machines for selection.

### DETAILED DESCRIPTION OF THE INVENTION

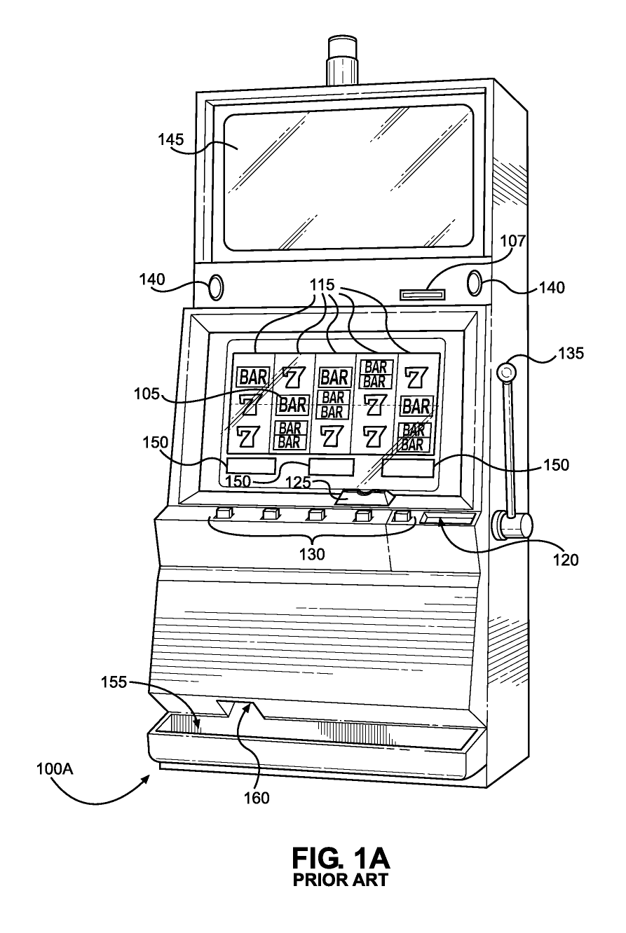

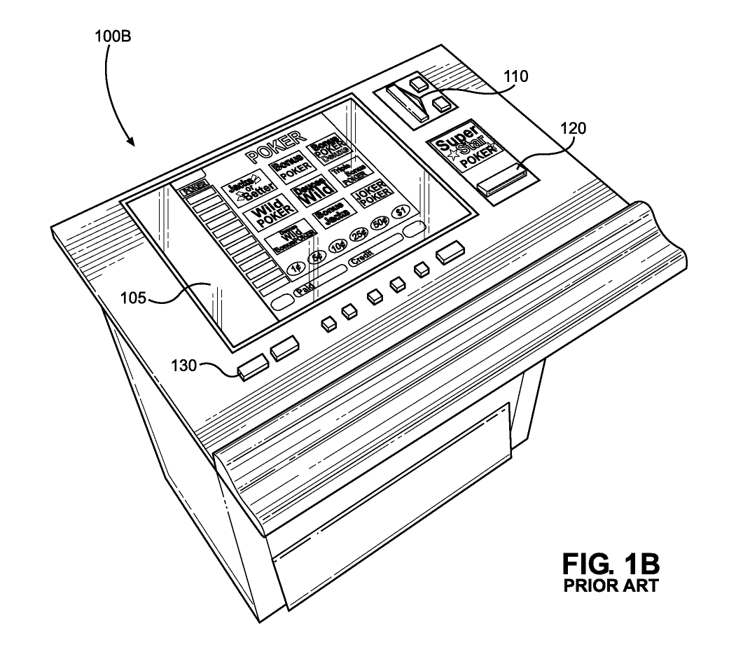

The present invention will now be described more fully with reference to the accompanying drawings. It should be understood that the invention may be embodied in many different forms and should not be construed as limited to the embodiments set forth herein. Throughout FIGS. 1-5, like elements of the invention are referred to by the same reference numerals for consistency purposes.

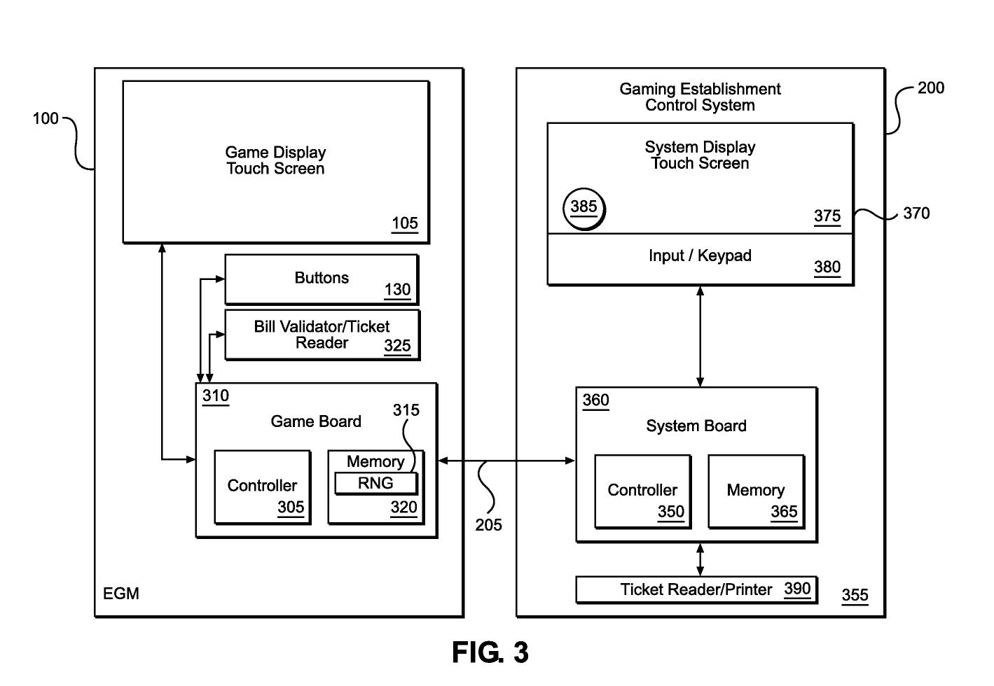

FIG. 1A shows a prior art electronic gaming machine (“EGM”) 100A with a number of components. A display 105 is used to show game play and resulting outcomes, and may be in the form of a video display (shown), or alternatively, physical reels. A player tracking card reader 107 may be included to track play. Touch screen displays are included on most EGMs and provide a flexible interface for operation of EGM 100A, including displaying symbols 115 during play. Other components include a bill validator (see FIG. 3). Older EGMs also included a coin acceptor, although coin acceptors are no longer widely used in new EGMs. Both the bill validator and coin acceptor are housed inside EGM 100A into which bills may be inserted through bill slot 120 and coins may be inserted through coin head 125, respectively. Buttons 130 on the exterior of EGM 100A are used to control certain EGM operations in conjunction with touch screen display 105. A handle 135 may also be used to initiate play of a game and speakers 140 are used to provide sounds in conjunction with game play and other EGM operations. EGMs further include a top box 145 for displaying pay tables, artwork, advertising or other types of information either on fixed glass or on other displays such as an integrated video panel. Top box 145 may be fitted with a liquid crystal display (“LCD”) screen to permit aspects of game play from either a base game or a secondary game to be shown in top box 145. Meters 150 for tracking credits available for play, amount won on a particular play, number of coins bet, number of paylines played and other amounts are positioned near the bottom of screen 105. For machines capable of accepting coins, a coin tray 155 at the bottom of EGM 100A is used to catch coins as they are dispensed to a player. It is also common for EGM 100A to include a ticket-in, ticket-out (“TITO”) component that may be part of the bill validator housed inside of EGM 100A that may accept bar coded credits through slot 120 and for which the value of the credits is displayed on meters 150 upon a ticket being inserted. For purposes of the present invention, a EGM 100A is not equipped with a ticket printer and does not have ticket printing capabilities. However, it does have the capability to read and accept tickets to load credit values from a ticket onto the credit meter as is well known in the art.

FIG. 1B shows a prior art EGM in the form of a bar-top video poker machine 100B with a touchscreen for playing one or more video poker games. Bar-top EGMs 100B of the type shown in FIG. 1B are used extensively in bars and small establishments offering play on gaming machines where the total number of EGMs positioned around a bar is typically in the range of 10 and 15 EGMs. Operation of a bar-top EGM 100B of the type in FIG. 1B is the same as that for the EGM of FIG. 1A where a random number generator is used to select a random number that is correlated to a game outcome that is shown on display 105. Although it is known to use a separate ticket printer in the EGM to print bar coded tickets from ticket slot 110, for purposes of the present invention, EGM 100B is not equipped with a ticket printer. However, it does have the capability to read an accept tickets to load credit values from a ticket onto the credit meter as is well known in the art. It should be understood that any reference to an EGM 100 herein applies to any EGM including a stand up EGM of the type shown in FIG. 1A and referenced as 100A and the bar top EGM of the type shown in FIG. 1B and referenced as 100B, as well as any other EGM of differing formats on which a player plays a game.

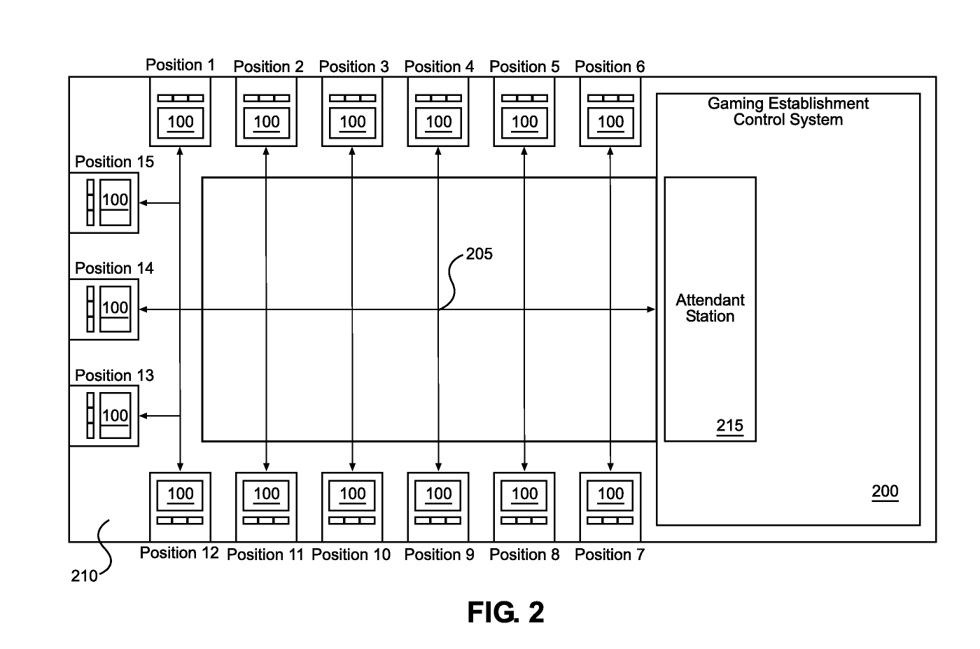

FIG. 2 is a block diagram showing a group of EGMs 100 on a network connection 205 between a gaming establishment control system 200 (“GECS”) and each of EGMs 100. It should be understood that the network may be set up with any number of EGMs, but it will typically be used in an operation where a live attendant has visual contact with a number of machines that he is responsible for monitoring. In the configuration of FIG. 2, there are fifteen bar-top EGMs 100 around a bar counter area 210 where patrons may order food and drinks, and play EGMs 100. EGMs 100 are labeled at positions 1-15. One or more attendants working behind bar counter area 210 may provide service to patrons and also operate an attendant station 215 of GECS 200.

FIG. 3 is a block diagram of a single EGM 100 connected to GECS 200 for purposes of showing details of certain internal components of EGM 100 and GECS 200 in FIG. 2. All operational functions of EGM 100 are controlled by a controller 305 such as a microprocessor housed inside EGM 100 that is resident on a game board 310. The controller executes instructions that include operation of a random number generator 315 (“RNG”) that is usually implemented in software and stored in a memory 320. The internal components of EGM 100 are well known to those of ordinary skill in the art. Game outcomes are determined based on the results corresponding to the numbers selected by RNG 315. Bill validator 325 has the capability to read and accept currency in the form of bills and is also has the capability to accept printed tickets or vouchers from a player. The value of any bills, tickets or vouchers accepted are added in the form of credit to meters 150 on EGM 100. Bill validator 325 does not include a ticket printer or otherwise have ticket printing capabilities.

GECS 200 is connected to EGM 100. GECS 200 is typically connected to EGMs 100 either through a separate interface board (not shown) or directly to components of EGM 100 including but not limited to game board 310. A communication link which may be in the form of network 205 is established between GECS 200 and EGM 100. Network 205 connects to all EGMs 100 in the establishment where EGMs 100 are located.

GECS 200 also includes a number of components. All operational functions of GECS 200 are controlled by a controller 350 such as a microprocessor housed inside GECS system housing 355 that is resident on a system board 360. Controller 350 executes instructions that include operations for accepting full or partial cash-out requests from an EGM 100 and allowing an attendant to make a payment to the player based on instructions from the player. Once the player is paid, GECS 200, through controller 350 instructs the requesting EGM to deduct credits on EGM 100 by an amount of the cash-out. Software for performing cash-out operations and other GECS operations is stored in memory 365 on system board 360. An attendant interface 370 located at attendant station 215 includes a touch screen 375, and optionally may include other input devices such as a combination of keyboard, mouse, trackpad, trackball and/or other input devices represented by input/keypad combination 380. An audio device such as a speaker 385 may also be included. A ticket reader/printer 390 has capabilities for both reading tickets and printing tickets. Printed tickets from ticket reader/printer 390 may be provided to a player by the attendant and then inserted into bill validator/ticket reader 325 on any of EGMs 100 in the system to load credits onto an EGM 100. A player may also provide a ticket to the attendant to be inserted into ticket reader/printer 390 for the purpose of cashing out. Attendant interface 370 permits the attendant to interface with GECS 200 by receiving and transmitting instructions and information through GECS 200 over network 205 to each of EGMs 100. It will be recognized that the individual components of GECS 200 are well known to those of ordinary skill in the art.

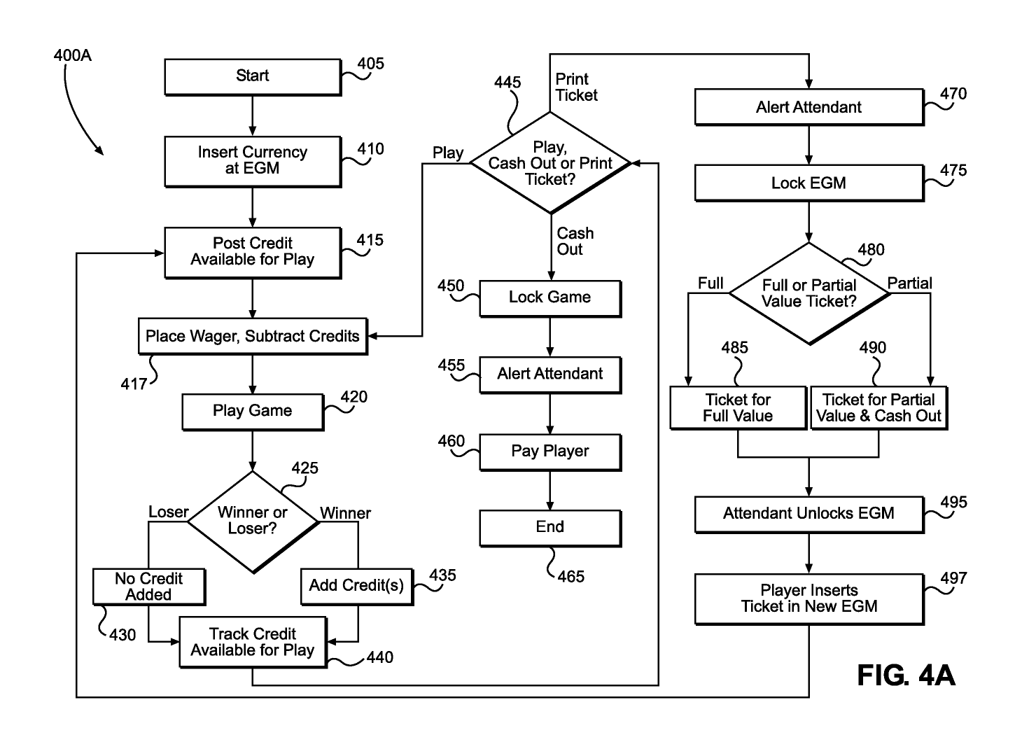

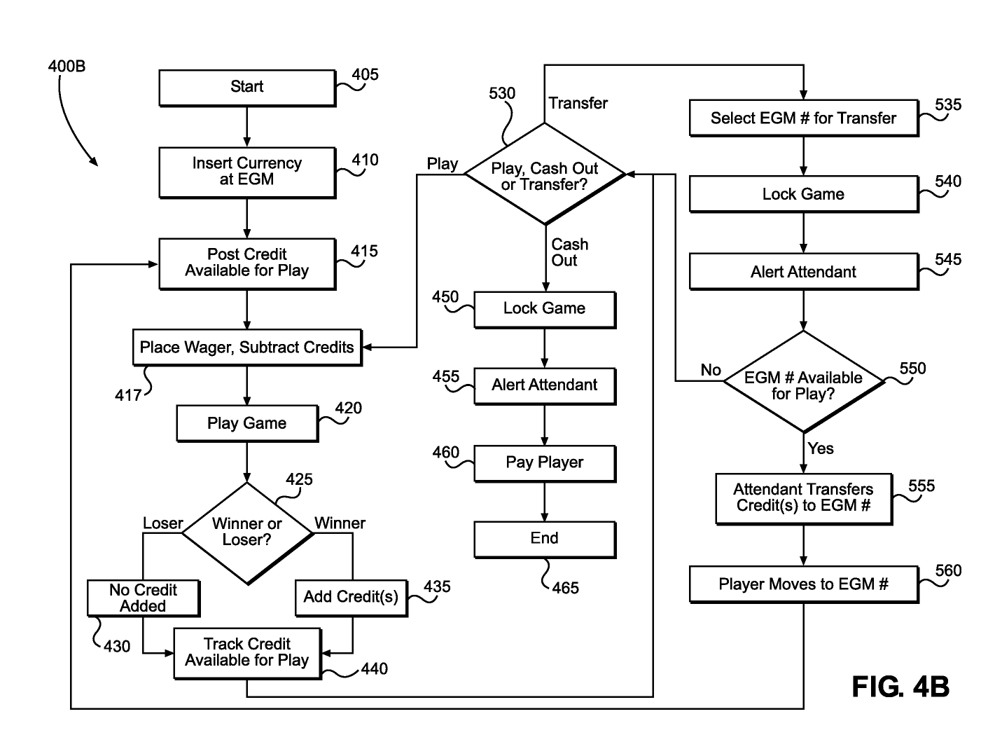

FIG. 4A shows a flow chart 400A of operation of a system with EGMs 100 and GECS 200 in which a player is able to continue play, cash out or receive a printed ticket with credit value that may be inserted into any EGM 100 at a gaming establishment to load the credit value onto a chosen EGM. Referring to FIG. 4A, start 405 represents the point at which a player sits down at EGM 100 to begin play. The player initially inserts a bill into bill validator 325 through slot 120 (or, coins into coin head 125). Alternatively, the player may insert a printed ticket into ticket reader 325 through slot 120 from a previous cash-out provided by the attendant from a prior game session at the gaming establishment at step 410. The currency or ticket is accepted by EGM 100 and the appropriate credit value is posted on the machine at step 415 so that it now available for play. These credits are displayed to the player on credit meter 150. The player then selects the game to be played. If it is an EGM offering video poker games of the type shown in FIG. 1B, the player may have a choice between “Bonus Poker,” “Deuces Wild,” “Jacks or Better,” or any of a number of other video poker games programmed with different paytables. On a slot type EGM as shown in FIG. 1A, the player may select between different slot games, and also choose, for example, the number of lines to play and the number of coins per line which is shown on one of meters 150. A “total bet” which depends on the number of lines and the number of coins per line is shown on a total bet meter which is another one of meters 150.

A wager is placed and credits are subtracted from the total available at step 417 with the new total being reflected on one of meters 150 for displaying credits available. The game is started and the player uses buttons 130 to initiate play of the game at step 420. Appropriate game graphics are shown on display 105 such as spinning reels 115 (or the display of cards on a video poker game), and corresponding game sounds come from speakers 140. Also at play game step 420, RNG 315 is executed on controller 305 and a game outcome is chosen. Once the outcome is reached, the outcome is displayed on game display 105 for the player to see. It is then determined whether the outcome is a winner or loser at step 425. If it is a losing outcome at step 430, no credits are awarded. If it is a winning outcome, the player is notified that s/he has won and is awarded the appropriate credit amount at step 435. An indication on display 105 and meters 150 shows the win and the amount of credit added. Once the credit amount is adjusted after completion of game play at step 440, the player may choose to play again, cash-out or transfer credits to another EGM at step 445. If the player chooses to play again, he is returned to step 417 where he may place another wager and begin the play cycle again.

Instead of continuing play after step 445, the player may elect to either cash-out and stop playing, or request a printed ticket from the attendant to transfer all or a portion of available credits to a different EGM for continued play. In the event of a cash-out, the player presses a button on touch screen 105 or a physical button 130 and a cash-out request signal is sent from EGM 100 over network 205 to GECS 200. Once a cash-out request has been sent, the EGM from which the signal is sent is automatically “locked” at step 450. This prevents the player from any further operations on the EGM during the cash-out process. The cash-out signal is received at GECS 200 and alert is displayed on attendant interface 370 at attendant station 215 in the form of a cash-out message on GECS screen 375. It is also possible to accompany a cash-out message with an audio signal so that the attendant is alerted to the need for servicing a patron cash-out. The audio signal may be played over speaker 385 in attendant interface 370. The cash-out message displayed indicates the position number of the EGM from which the request was issued and the amount of the cash-out value. The attendant then pays the player at step 460 and resets the EGM where the cash-out was handled so that the EGM is available for play again. That ends the process at step 465 for a cash-out.

In the event that the player elects to receive a printed ticket at step 445, the player first alerts the attendant at step 470. The player may alert the attendant by simply speaking to the attendant or by alerting the attendant through an input on EGM 100 that sends a request signal to GECS 200. When received at GECS 200, the alert is shown on screen 375 and/or through an audio alert on speaker 385. EGM 100 is then locked at step 475 so that the attendant can print the ticket on ticket printer 390 by inputting instructions to GECS 200 to retrieve credit information from EGM 100. The attendant must first determine whether the player wants the ticket to have the full value of the available credits placed on the ticket, or only a portion of the credits placed on the ticket. This decision is made at step 480 based on instructions from the player. The instructions from the player may be told directly to the attendant or they may be provided using inputs on EGM 100.

If the full value of the available credits is to be issued in the form of a printed ticket, the attendant prints the ticket at GECS from ticket printer 390 and provides the ticket to the player at step 485. If a portion of the available credits is to be issued in the form of a printed ticket, the attendant carries out two tasks at step 490: (1) The attendant cashes out the difference between the available credits and pays the customer; and (2) The attendant inputs the amount of the printed ticket into GECS 200 and provides the printed ticket to the player. The attendant then unlocks EGM 100 where the player had been at step 495 freeing up EGM 100 to be used by a new player. The player may then take the printed ticket and insert it into a different EGM at step 497 to start a new play session. This is reflected in flowchart 400A where the player is returned from step 497 to step 415.

FIG. 4B shows a flow chart 400B of an alternative operation of the system with EGMs 100 and GECS 200 in which a player is able to continue play, cash out or transfer credits on EGM 100 at a gaming establishment. Referring to FIG. 4B, the operation of steps 405-440 are the same as for flow chart 400A of FIG. 4A. Once the credit amount is adjusted after completion of game play at step 440, the player may choose to play again, cash-out or transfer credits to another EGM at step 530. If the player chooses to play again, he is returned to step 417 where he may place another wager and begin the play cycle again.

Instead of continuing play after step 530, the player may elect to either cash-out and stop playing, or transfer available credits to a different EGM for continued play. In the event of a cash-out, the process is the same as steps 450-465 of flowchart 400A of FIG. 4A.

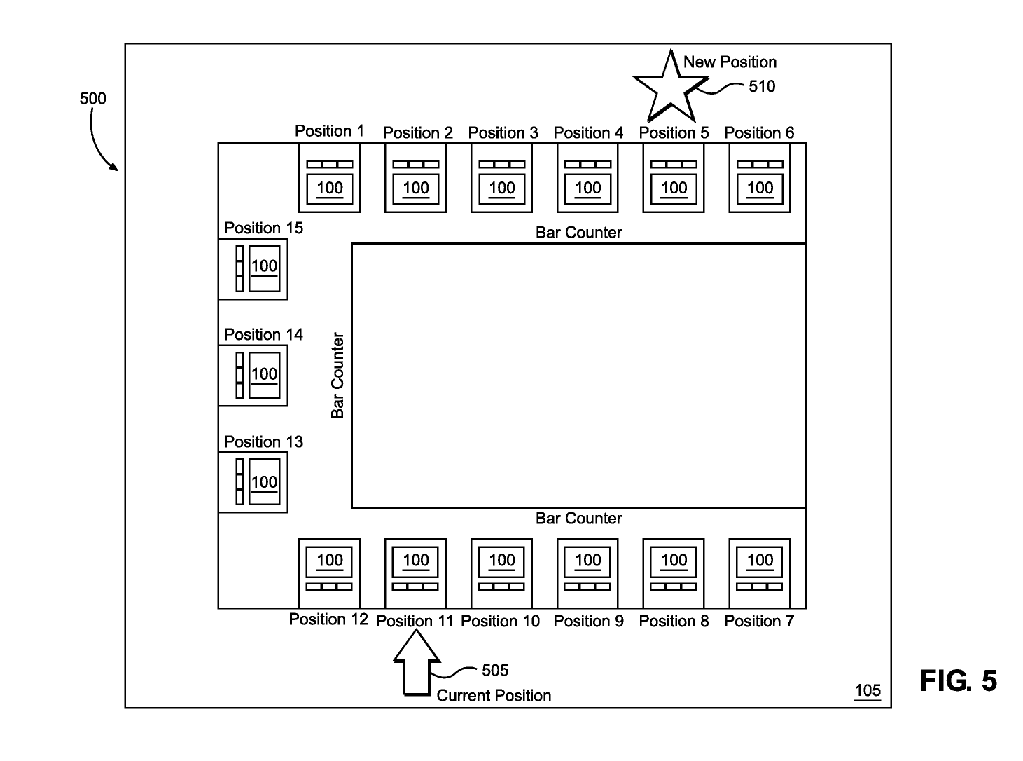

In the event that the player elects a transfer at step 530, the player may then select a different EGM on which he desires to play at step 535. The selection may be made by selecting a new EGM position number from the EGMs that are available to play. In one embodiment, the player may be offered a map 500 of the available EGMs on display 105 of the EGM where he is currently playing, in a form similar to the map shown on FIG. 5. The map may include an indicator showing the current position 505, and the player may then simply touch the new desired position where he wants to play. An indicator such as a star 510 or other symbol may appear to confirm the selection. Also, EGMs that are currently in use may be shown as not available for play, for example, by blocking them out, or showing them in a different color such as gray.

Once the player selects the EGM for a transfer, the EGM where he is currently playing is automatically locked at step 540 to prevent any further operations on that EGM during the transfer process. At step 545, a transfer request signal sent from the locked EGM is received at GECS 200 and an alert message is displayed to the attendant on attendant interface 370 at attendant station 215 in the form of a transfer alert on GECS screen 375. It is also possible to accompany a transfer alert with an audio signal so that the attendant is alerted to the need for servicing a patron cash-out. The transfer message displayed indicates the position number of the EGM from which the request was issued, the number of credits to be transferred and the position number of the new EGM to which the transfer should be made. The attendant determines whether the newly designated EGM is available for play at step 550. If not, the attendant rejects the request and the player is returned to step 530 where he can continue play on his current EGM, or elect a cash-out or a transfer to a different EGM. If the newly designated EGM is available for play, the attendant instructs GECS 200 through interface 370 to transfer the credits from the current EGM to the new EGM at step 555. The player then moves to the new EGM at step 560 to begin play using the transferred credits, and is returned to step 415 where the entire cycle begins again. Once the transfer is complete at step 560, the previously used EGM is unlocked for play automatically by GECS 200.

It should be understood that certain steps of the process may be implemented either through operations on EGM 100 and GECS 200 or manually through a conversation between the player and the attendant. For example, in an alternative embodiment, instead of the player using display 105 on EGM 100 to select an EGM at a new position for play after deciding to transfer credits at step 530, the player may tell the attendant that he wants to play at a different position and indicate to the attendant which EGM he wants to transfer to. The attendant may then lock EGM 100 at step 540 from GECS 200 and input the transfer action on attendant station 370 of GECS 200. In that case, the steps of selecting a new EGM (step 535) and alerting the attendant (step 545) would be combined and performed manually by the player before the attendant locks the current EGM at step 540. Also, in this embodiment, the attendant may be presented with map 500 of the gaming area on screen 375 so that the attendant can see current location 505 and complete the transfer of credit to new location 510 upon confirming that no credits attributable to a different player are available for play on the EGM at the newly desired location.

While the invention has been described with respect to the figures, it will be appreciated that many modifications and changes may be made by those skilled in the art without departing from the spirit of the invention. For example, while the invention is described with reference to printed tickets, it is also possible to provide available credits to players in other forms. Instead of a printed ticket, a player may be issued a card with a magnetic strip onto which data indicating the number of credits may be loaded and stored from GECS 200 and from which data can be read by an EGM 100 using a magnetic strip reader installed in EGM 100. It may also be possible to use other types of devices with Bluetooth, near field communication or other wireless transmit/receive capabilities, including but not limited to mobile phones to store data related to credit values from GECS 200 to EGM 100. In using a device of this type, the data stored may include a security code that corresponds to codes maintained in a database on GECS 200 that can be authenticated for use at an EGM at which the player provides the security code to the EGM. Any variation and derivation from the above description and drawings are included in the scope of the present invention as defined by the claims.

What is claimed is:

1. A system for use by players and a live attendant for permitting players to wager on games using credits and on which credits may be transferred from one electronic gaming machine (“EGM”) to another EGM with assistance from the live attendant, comprising:
a plurality of EGMs within an area of a gaming establishment including a first EGM in use by a player and a second EGM not in use by the player;
a gaming establishment control system (“GECS”) within the area of the gaming establishment in communication with each of the EGMs, comprising:
a processor for controlling GECS operation including receiving and transmitting signals on a network connected between each of the EGMs and the GECS;
a memory for storing a control program to be executed by the processor to perform operations on the GECS;
an attendant interface to the GECS for use by the attendant to receive signals and to input commands to the GECS, wherein at least one of the commands available to the attendant on the GECS is a command to transfer credits available on one EGM within the area of the gaming establishment to another EGM within the area of the gaming establishment after being instructed to make a transfer of credits by a player from a first EGM to a second EGM among the plurality of EGMs.

2. The system of claim 1 wherein the plurality of EGMs are within sight of the attendant interface.

3. The system of claim 1 wherein at least one of the signals is a request signal from the first EGM in use by the player requesting a transfer of credits from the first EGM to the second EGM wherein the request signal includes a position of the first EGM, a position of the second EGM and an amount of credit to be transferred.

4. The system of claim 3 wherein the first EGM is automatically locked upon transmission of the request signal.

5. The system of claim 3 wherein the request signal results in an alert being provided at the attendant interface in the form of either or both of: (a) a visual alert on a display; and/or (b) an audio alert on a speaker.

6. The system of claim 1 further comprising an EGM position map showing the respective positions of the plurality of EGMs wherein the EGM position map is presented on the first EGM to the player and from which the second EGM may be selected to make a transfer of credits.

7. The system of claim 1 further comprising an EGM position map showing the respective positions of the plurality of EGMs wherein the EGM position map is presented on the GECS to the attendant and on which the attendant may transfer credits from the first EGM to the second EGM.

8. A method of permitting players to transfer credits from one electronic gaming machine (“EGM”) to another EGM among a plurality of EGMs in a gaming establishment with assistance from a live attendant operating a gaming establishment control system in communication with each of the EGMs, comprising:
(a) establishing a session of game play for a player on a first EGM among the plurality of EGMs in which the player has credits available for play on the first EGM;
(b) wagering credits by the player for play of a game on the first EGM
(c) completing the session of game play on the first EGM;
(d) tracking credits available for play on the first EGM on a credit meter depending on the number of credits wagered and awarded upon completion of play;
(e) offering the player an option for remaining credits available, to: (i) continue play; (ii) cash out; or (iii) transfer credits from the first EGM to a second EGM among the plurality of EGMs;
(f) wherein, if the player selects to continue play, the player is returned to step (b);
(g) wherein, if the player selects to cash out, the live attendant makes a payment to the player equal to the value of the credits available; and
(h) wherein, if the player selects to transfer credits, the live attendant inputs a command to the GECS to transfer all or a portion of the credits available from the first EGM to the second EGM.

9. The method of claim 8 wherein each of the EGMs is within sight of the attendant interface.

10. The method of claim 8 further comprising transmitting a request signal from the first EGM in use by the player requesting a transfer of credits from the first EGM to the second EGM wherein the request signal includes the position of the first EGM, the position of the second EGM and the amount of credit to be transferred.

11. The method of claim 9 wherein the first EGM is locked upon transmitting the request signal.

12. The method of claim 11 wherein the request signal results in an alert being provided at the GECS in the form of either or both of: (a) a visual alert on a display; and/or (b) an audio alert on a speaker.

13. The method of claim 8 wherein an EGM position map indicating the respective positions of the plurality of EGMs is presented on the first EGM to the player and from which a second EGM may be selected to make a transfer of credits.

14. The method of claim 8 wherein an EGM position map indicating the respective positions of the plurality of EGMs is presented on the GECS to an attendant and on which the attendant may transfer credits from the first EGM to the second EGM.

15. A method of transferring credits from a first electronic gaming machine (“EGM”) to a second EGM among a plurality of EGMs in a gaming establishment through an interactive exchange between a player completing a play session at a first EGM and a live attendant operating a gaming establishment control system (“GECS”) in communicative connection with each of the EGMs, comprising:
(a) establishing a play session by the player on the first EGM in which the player has credits available for play on the first EGM;
(b) wagering credits for play of a game on the first EGM
(c) tracking credits available for play on the first EGM on a credit meter depending on the number of credits wagered and awarded during play;
(d) completing the play session on the first EGM;
(e) determining whether any credits remain available to the player upon completion of the play session on the first EGM;
(e) if credits remain available to the player upon completion of the play session, offering the player an option on a display of the first EGM, to: (i) continue play using remaining credits; (ii) cash out remaining credits; or (iii) transfer remaining credits from the first EGM to a second EGM among the plurality of EGMs selected by the player from among the plurality of EGMs;
(f) wherein, if the player opts to continue play, the player is returned to step (b);
(g) wherein, if the player opts to cash out, the player requests that the live attendant make a payment to the player equal to all or a portion of the value of the remaining credits; and
(h) wherein, if the player opts to transfer all or a portion of the remaining credits:
initiating a request to transfer all or a portion of the remaining credits by the player at the first EGM;
causing a lock-out action on the first EGM;
inputting a command to the GECS by the live attendant to transfer all or a portion of the remaining credits from the first EGM to the second EGM;
initiating a new game play session on the second EGM using credits transferred from the first EGM; and
unlocking the first EGM.

16. The method of claim 15 wherein each of the EGMs is within sight of the attendant interface.

17. The method of claim 15 further comprising transmitting a request signal from the first EGM that is in use by the player requesting a transfer of credits from the first EGM to the second EGM wherein the request signal includes the position of the first EGM, the position of the second EGM and the amount of credit to be transferred.

18. The method of claim 15 wherein the first EGM is locked upon transmitting the request signal.

19. The method of claim 18 wherein the request signal results in an alert being provided at the GECS in the form of either or both of: (a) a visual alert on a display; and/or (b) an audio alert on a speaker.

20. The method of claim 15 wherein an EGM position map indicating the respective positions of the plurality of EGMs is presented on the first EGM to the player and from which the second EGM may be selected to make a transfer of credits.

21. The method of claim 15 wherein an EGM position map indicating the respective positions of the plurality of EGMs is presented on the GECS to an attendant and on which the attendant may transfer all or a portion of the credits from the first EGM to the second EGM.

22. A system for use by players and a live attendant for permitting players to wager on games using credits and on which credits may be transferred from one electronic gaming machine (“EGM”) to another EGM with assistance from the live attendant, comprising:
a plurality of EGMs within an area of a gaming establishment including a first EGM in use by a player and a second EGM not in use by the player;
a gaming establishment control system (“GECS”) within the area of the gaming establishment in communication with each of the EGMs, comprising:
a processor for controlling GECS operation including receiving and transmitting signals on a network connected between each of the EGMs and the GECS;
a memory for storing a control program to be executed by the processor to perform operations on the GECS;
an attendant interface to the GECS for use by the attendant to receive signals and to input commands to the GECS, wherein at least one of the commands available to the attendant on the GECS is a command to issue a voucher for all or a portion of credits available on the first EGM for use on the second EGM after a request by the player.

23. The system of claim 22 wherein the plurality of EGMs are within sight of the attendant interface.

24. The system of claim 22 wherein at least one of the signals is a request signal from the first EGM in use by the player requesting a credit voucher wherein the request signal includes a position of the first EGM and an amount of credit to be allocated to the voucher.

25. The system of claim 24 wherein the first EGM is automatically locked upon transmission of the request signal.

26. The system of claim 24 wherein the request signal results in an alert being provided at the attendant interface in the form of either or both of: (a) a visual alert on a display; or (b) an audio alert on a speaker.

27. The system of claim 22 further comprising a device for storing data indicating the available credits wherein the device is one of a type from a group comprising: (a) a ticket printer that prints a ticket bearing the data; (b) a magnetic strip encoder for providing the data on a magnetic strip on a card; or (c) a transmitter for transmitting the data to a mobile computing device with a memory for storing the data and that transmits the data to an EGM capable of receiving the data.

28. The system of claim 22 wherein the at least one of the commands available to the attendant on the GECS includes: (a) a command to lock the first EGM; and/or (b) a command to unlock the first EGM.

29. A method of permitting players to transfer credits from one electronic gaming machine (“EGM”) to another EGM among a plurality of EGMs in a gaming establishment with assistance from a live attendant operating a gaming establishment control system in communication with each of the EGMs, comprising:
(a) establishing a session of game play for a player on a first EGM among the plurality of EGMs in which the player has credits available for play on the first EGM;
(b) wagering credits by the player for play of a game on the first EGM;
(c) completing the session of game play on the first EGM;
(d) tracking credits available for game play on the first EGM on a credit meter depending on the number of credits wagered and awarded upon completion of play;
(e) offering the player an option for remaining credits available, to: (i) continue play; (ii) cash out; or (iii) receive a voucher for all or a portion of credits available on the first EGM after a request by the player;
(f) wherein, if the player selects to continue play, the player is returned to step (b);
(g) wherein, if the player selects to cash out, the live attendant makes a payment to the player equal to the value of the credits available; and
(h) wherein, if the player selects to receive a voucher, the live attendant inputs a command to the GECS to issue a voucher to the player that is used to load credits onto another EGM.

30. The method of claim 29 wherein each of the EGMs is within sight of the attendant interface.

31. The method of claim 29 further comprising transmitting a request signal from the first EGM in use by the player to receive a voucher, wherein the request signal includes the amount of credit to be indicated on the voucher.

32. The method of claim 30 wherein the first EGM is locked upon transmitting the request signal.

33. The method of claim 32 wherein the request signal results in an alert being provided at the GECS in the form of either or both of: (a) a visual alert on a display; and/or (b) an audio alert on a speaker.

34. The method of claim 29 further comprising storing data indicating available credits in a voucher in a form from a group comprising: (a) a printed ticket bearing the data that is inserted in an EGM; (b) a magnetic strip on a card that is inserted in an EGM; or (c) a mobile computing device with a memory for storing the data and that transmits the data to an EGM capable of receiving the data.

35. The method of claim 29 further comprising the attendant entering a command on the GECS to lock the first EGM.

36. A method of storing credits available on a first electronic gaming machine (“EGM”) for use on a second EGM among a plurality of EGMs in a gaming establishment through an interactive exchange between a player completing a play session at a first EGM and a live attendant operating a gaming establishment control system (“GECS”) in communicative connection with each of the EGMs, comprising:
(a) establishing a play session by the player on the first EGM in which the player has credits available for play on the first EGM;
(b) wagering credits for play of a game on the first EGM
(c) tracking credits available for play on the first EGM on a credit meter depending on the number of credits wagered and awarded during play;
(d) completing the play session on the first EGM;
(e) determining whether any credits remain available to the player upon completion of the play session on the first EGM;
(e) if credits remain available to the player upon completion of the play session, offering the player an option on a display of the first EGM, to: (i) continue play using remaining credits; (ii) cash out remaining credits; or (iii) store all or a portion of remaining credits from the first EGM on a voucher that may be used at an EGM selected by the player from among the plurality of EGMs;
(f) wherein, if the player opts to continue play, the player is returned to step (b);
(g) wherein, if the player opts to cash out, the player requests that the live attendant make a payment to the player equal to the value of the remaining credits; and
(h) wherein, if the player opts to store all or a portion of the remaining credits:
initiating a request to store a designated amount equal to all or a portion of the remaining credits by the player on a voucher;
inputting a command to the GECS by the live attendant to store the designated amount of remaining credits specified in the request; and
issuing a voucher to the player with data indicating the designated amount of remaining credits.

37. The method of claim 36 wherein each of the EGMs is within sight of the attendant interface.

38. The method of claim 36 further comprising transmitting a request signal from the first EGM that is in use by the player requesting storage of credits from the first EGM wherein the request signal includes the designated amount of credit to be stored.

39. The method of claim 36 wherein the first EGM is locked upon transmitting the request signal.

40. The method of claim 39 wherein the request signal results in an alert being provided at the GECS in the form of either or both of: (a) a visual alert on a display; and/or (b) an audio alert on a speaker.

41. The method of claim 36 wherein the voucher is in a form from a group comprising: (a) a printed ticket bearing the data that is inserted in an EGM; (b) a magnetic strip on a card that is inserted in an EGM; or (c) a mobile computing device with a memory for storing the data and that transmits the data to an EGM capable of receiving the data.

42. The method of claim 36 further comprising the attendant entering a command on the GECS to lock the first EGM.
